(19) United States
(12) Patent Application Publication
(10) Pub. No.: US 2026/0324656 A1
(43) Pub. Date: Oct. 22, 2026

(54) System and Method for Binding Proteins to Brown Rice Flour to Improve Viscoelastic Properties of Brown Rice Flour Dough

(71) Applicant: John C. Limm, Robbinsville, NJ (US)

(72) Inventor: John C. Limm, Robbinsville, NJ (US)

(21) Appl. No.: 19/724,791

(22) Filed: Jun. 29, 2026

Related U.S. Application Data
(63) Continuation-in-part of application No. 19/007,395, filed on Dec. 31, 2024, now abandoned.
(60) Provisional application No. 63/719,726, filed on Nov. 13, 2024.

(51) Int. Cl. A21D 13/066; A21D 2/18; A21D 2/36; A21D 13/047

(52) U.S. Cl. CPC A21D 13/066; A21D 2/18; A21D 2/36; A21D 13/047

(57) ABSTRACT

The present invention is a system and method for producing a gluten-free dough for baking. Dry plant powder is provided that contains certain polysaccharides. The plant powder is derived from a group comprising slippery elm leaf, okra, and dioscorea polystachya. The plant powder is mixed with water to hydrate the plant powder and create polysaccharide chains that are swollen with water. Brown rice flour is added. The brown rice flour contains starch molecules albumin protein, and globulin protein. The polysaccharides bond to the albumin protein and the globulin protein with hydrogen bonds creating a mucilag. . The mucilage binds the starch molecules of the brown rice flour creating a viscoelastic dough.

### RELATED APPLICATIONS

This application is a continuation-in-part of U.S. Patent Application No. 19/007,395, filed Dec. 31, 2024, which claims the benefit of U.S. Provisional Application No. 63/719,726, filed Nov. 13, 2024.

### FIELD OF THE INVENTION

The present invention relates to compositions that include brown rice flour and can serve as a gluten-free substitutes for wheat-based flour in commercial baking applications. More particularly, the present invention relates to compositions that mix brown rice flour with one or more other proteins that bond to the brown rice flour and improve the viscoelastic properties of dough made from the brown rice flour.

### BACKGROUND OF THE INVENTION

Gluten is a structural protein that is naturally found in wheat, barley, rye, and some cultivars of oats. Gluten is the term that usually refers to the elastic structural proteins within a wheat grain, which primarily include gliadin and glutenin. Accordingly, gluten is present in flour that is made from such grains. Gluten has viscoelastic and adhesive properties, which give dough elasticity. This helps dough rise and keep its shape. When flour with gluten is used in dough, the gluten greatly affects the consistency of the dough. Prior to baking, the gluten enables the dough to be stretched, folded and repeatedly kneaded without breaking apart. After baking, the presence of gluten provides the final product with a soft, chewy texture.

In bread wheat, the presence of gluten accounts for up to 85% of the total protein. Although gluten rich flours are preferred in many baking recipes, some people have adverse reactions to consuming gluten. Many people react to gluten by feeling bloated and having trouble with digestion. Some people have allergic reactions, where the consumption of gluten can cause swelling and hives. Still others have Celiac Disease where the digestive tract can become damaged from the consumption of gluten. This causes the digestive tract to lose its ability to absorb nutrients. This can lead to malnutrition, weight loss, fatigue, delayed growth, and failure to thrive in infants.

The simplest treatment for people who are sensitive to gluten is to avoid products that contain gluten. That is, the simplest treatment is to avoid products that contain wheat flour. There are many gluten-free flours in the marketplace, such as rice flour, sorghum flour and tapioca flour that can be used in baking. However, doughs made from these alternate flours do not have the same viscoelastic properties as would dough made from wheat flour with gluten. The result is typically a baked good that is brittle and flat.

In the prior art, there have been many attempts to make a gluten-free flour that can create a viscoelastic dough similar to that of wheat flour. This is typically done by mixing white rice flour with a starch and a gum. The starch is typically potato starch or corn starch, which helps bind the flour together. The gum is typically xanthan gum or guar gum, which provides some elastic characteristics to the dough being produced. Such prior art compositions are exemplified by U.S. Patent Application Publication No. 2014/0322390 to Papanastasiou and U.S. Patent Application Publication No. 2018/0279628 to Routson.

One way to make dough from non-wheat flour perform more like wheat flour dough is to add non-gluten structural proteins to the non-wheat flour. One of the most common non-wheat flours used to make gluten free flour is white rice flour, which is known in the food industry simply as "rice flour." White rice flour is often used as a base because white rice flour is both inexpensive and plentiful. Furthermore, white rice flour rice. However, dough made from white rice flour is very inelastic. To make the white rice flour perform more like wheat flour when baking, many protein-rich additives have been mixed with the white rice flour. These protein additives include okra powder in various concentrations with other additives. Gluten-free flours that mix okra with white rice flour are exemplified by CN104336480A, CN111513113A, CN109463417B, and the publication by Chan DS, Wang ST, Chen MY, Sung WC, entitled "The effect of okra (Abelmoschus esculentus l.) Powder Addition on Qualities of Gluten-free Chiffon Cake", Food Sci Technol Int. 2024 Jul;30(5):485-494.

Mixing white rice flour with okra powder improves the texture of the flour. However, in order to make the white rice flour as nutritious and protein rich as wheat flour, many additional ingredients must be added. The result is a rice-based flour that has many ingredients. This makes the flour both difficult and expensive to produce. As such, the cost of a bag of gluten-free flour can be many times more expensive than a similarly sized bag of regular wheat flour. In addition, although the use of additives helps, the gluten-free flour still does not produce an elastic dough that has viscoelastic properties that are comparable to wheat flour dough.

A need therefore exists for an improved composition for a gluten-free flour that is more nutritious, less complicated to make, less expensive to produce, and is capable of creating a dough with viscoelastic properties similar to that of wheat dough. These needs are met by the present invention as described and claimed below.

### SUMMARY OF THE INVENTION

The present invention is a system and method for producing a gluten-free dough for baking. Dry plant powder is provided that contains certain polysaccharides. The plant powder is derived from a group comprising slippery elm leaf, okra, and dioscorea polystachya.

The plant powder is mixed with water to hydrate the plant powder and create a pre-dough containing polysaccharide chains that are swollen with water. Brown rice flour is mixed into pre-dough. The brown rice flour contains starch molecules, albumin protein, and globulin protein. The polysaccharides chains in the pre-dough bond to the albumin protein and the globulin protein with hydrogen bonds creating a mucilage. The mucilage binds the starch molecules brown rice flour creating a viscoelastic dough.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 shows a schematic that explains the creation of binding mucilage when combing brown rice flour with selected plant powder containing the appropriate polysaccharides;

FIG. 2 shows a schematic of the methodology needed to formulate the present invention composition;

FIG. 3 shows a schematic of the testing procedure used to determine the viscoelastic properties of samples;

FIG. 4 is a graph showing test results for a composition of a dough made from a first formulation of a gluten-free flour;

FIG. 5 is a graph showing test results for a composition of a dough made from a second formulation of a gluten-free flour;

FIG. 6 is a graph showing test results for a composition of a dough made from a third formulation of a gluten-free flour;

FIG. 7 is a graph showing test results for a composition of a dough made from a fourth formulation of a gluten-free flour; and

FIG. 8 is a graph showing test results for a composition of a dough made from a fifth formulation of a gluten-free flour.

### BRIEF DESCRIPTION OF THE INVENTION

Although the present invention gluten-free flour formulation can be embodied in many ways, only a few exemplary formulations are illustrated and described. The exemplary formulations are being shown for the purposes of explanation and description. The exemplary formulations are selected in order to set forth some of the best modes contemplated for the invention. The described formulations, however, are merely exemplary and should not be considered as limitations when interpreting the scope of the appended claims.

Oryza sativa is the most common species of cultivated rice and is subdivided into long-grain indica and short-grain japonica. When the rice is grown, brown rice is considered the whole grain portion of the rice seed that contains both the bran and the germ. White rice is a mechanically processed grain that has the bran and the germ removed to make the rice softer and faster to cook. Since brown rice contains the bran and the germ, the brown rice contains more fiber, vitamins and minerals than does white rice. Furthermore, brown rice contains significantly more proteins than does the processed white rice. The primary proteins that are present in brown rice that is not present in white rice includes albumins and globulins.

Albumins constitute roughly 4% to 22% of the total protein in brown rice. Albumins are heavily concentrated in the outer bran and germ of the brown rice. Should the brown rice be milled and polished into white rice, nearly all of the albumin proteins are stripped away. Accordingly, it will be understood that brown rice contains significant amounts of albumins and white rice does not.

Brown rice albumin is a water-soluble monomeric protein with a molecular weight generally ranging between 10 kDa to 60 kDa composed largely of alpha- helix, beta-sheet, and beta-turn secondary structures. Brown rice albumin is distinct for its high proportion of acidic amino acids, particularly glutamic and aspartic acids.

Globulin proteins make up about 5% to 13% of the protein profile in brown rice. Like albumin, globulin reside primarily in the outermost aleurone layer of the bran. As such, the milling a polishing processes used to create white rice eliminate the vast majority of the globulin.

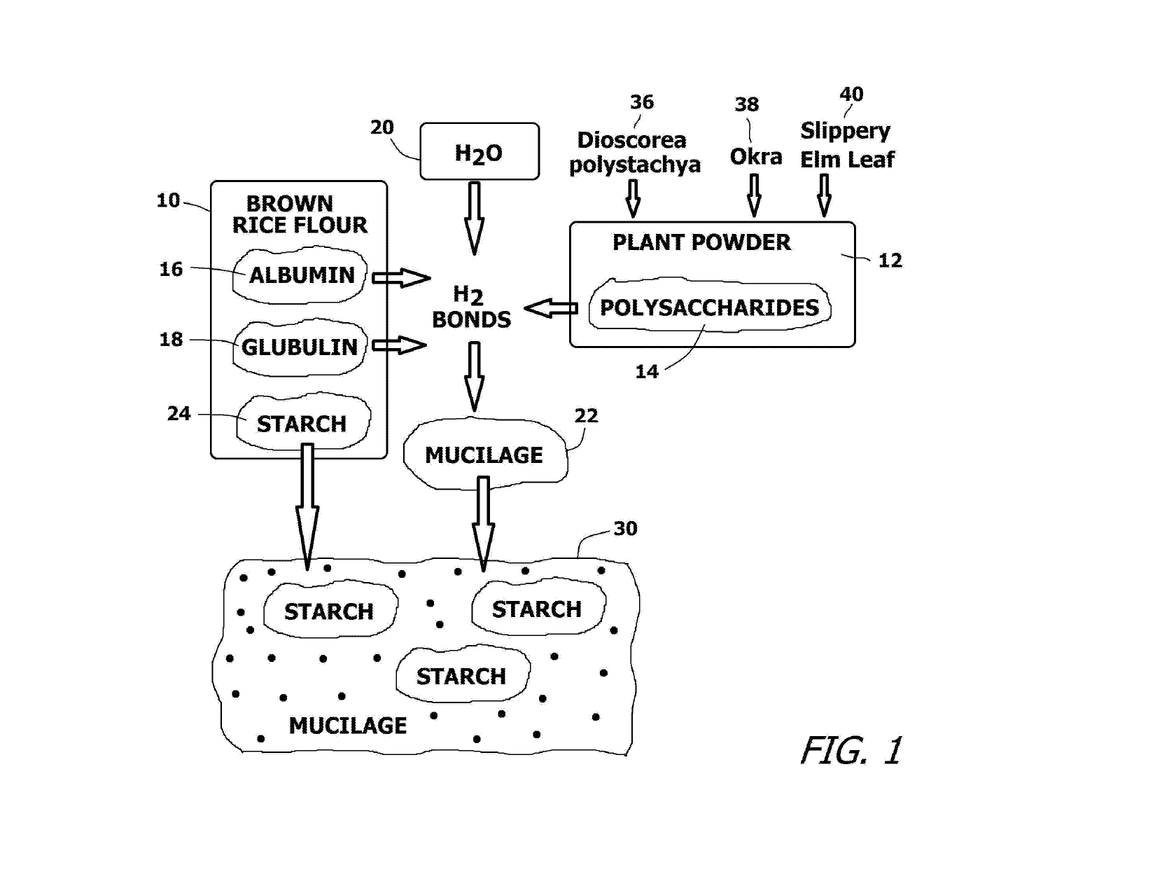

Referring to FIG. 1, it will be understood that inventor has discovered that when brown rice flour 10 is mixed with specific plant powders 12 that contain certain polysaccharides 14, the polysaccharides 14 bond with the albumin proteins 16 and globulin proteins 18 in the presence of water 20. This produces a complex polymer/protein networks of mucilage 22. The polysaccharide chains interact with albumin protein 16 and globulin protein 18 through hydrogen bonds. The resulting mucilage 22 covers and binds the various starch molecules 24 in the brown rice flour 12, which are primarily C₆H₁₀05. The starch in wheat flour is also C₆H₁₀05. However, in wheat flour the molecules of starch are joined by polymeric polysaccharide made of numerous glucose units. In brown rice flour 10, the same starch molecules 24 exists. However, there is no glucose to bind the molecules of starch together. In the present invention, the polysaccharides 14 from the selected plants powders 12 create bonded polysaccharide chains that swell with water 20 to form the mucilage 22. The mucilage 22 binds the molecules of starch 24 together in place of gluten, creating a final dough 30 that emulates the viscoelastic properties of traditional flour dough.

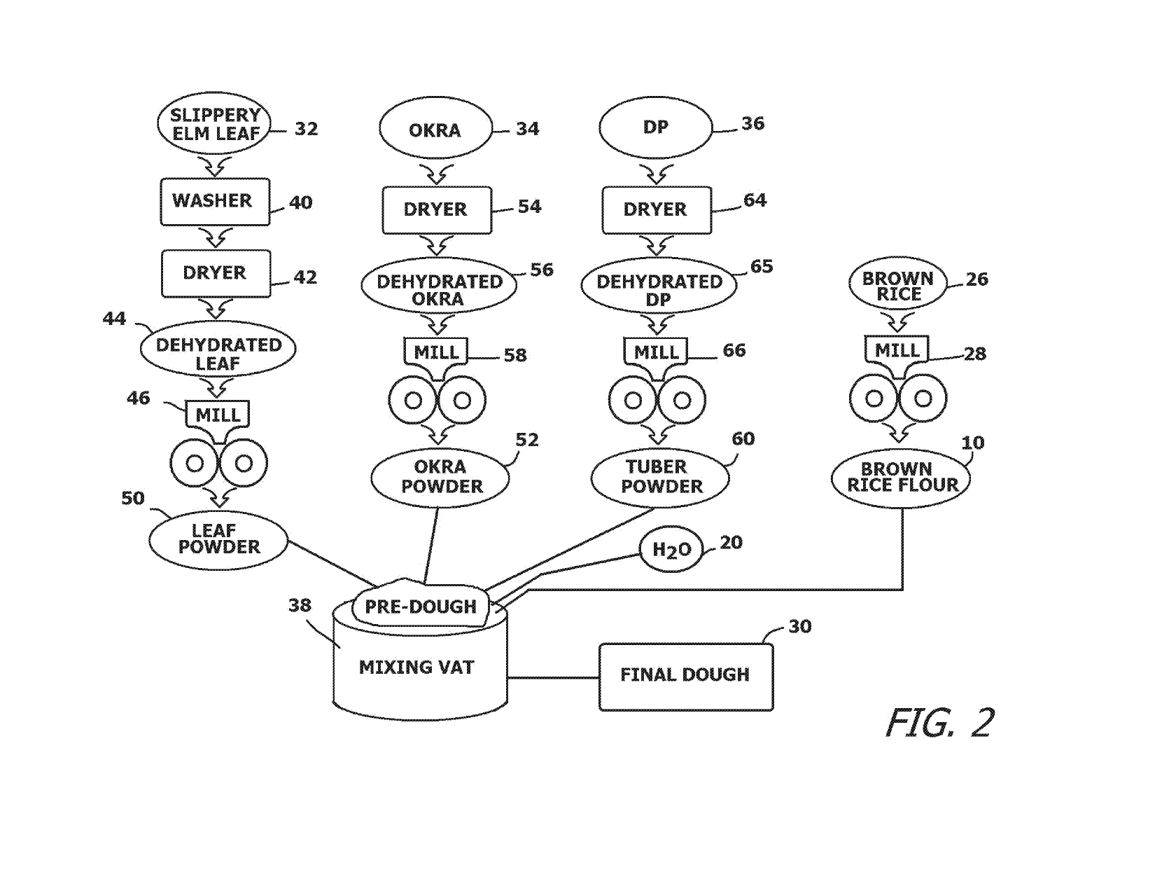

Referring to FIG. 2 in conjunction with FIG. 1, it can be seen that the brown rice 26 is grown, harvested, and dried in a traditional manner. The dry brown rice 26 is then processed in a mill 28. This produces the brown rice flour 10. The fibrous plants that contain the suitable polysaccharides 14 include slippery elm leaf 32, okra 34 and Dioscorea polystachya 36, which is commonly known as Chinese yam. One, all, or some of these fibrous plants 32, 34, 36 are dried and milled into plant powder 12. The plant powder 12 contains the polysaccharides 14 needed to react with the albumin proteins 16 and globulin proteins 18 of the brown rice flour 10.

The fibrous plants that contain the suitable polysaccharides 14 include slippery elm leaf 32, okra 34 and Dicscores polystachya 36, which is commonly known as Chinese yam. One, all, or some of these fibrous plants 32, 34, 36 are dried and milled into plant powder 12. The plant powder 12 contains the polysaccharides 14 needed to react with the albumin proteins 16 and globulin proteins 18 of the brown rice flour 10.

In a commercial setting, one or more of the plant powders 14 are added to a mixing vat 38. Enough water 20 wet dough is mixed/kneaded for up to five minutes to saturate the plant powders 12 and ensure that the polysaccharides 14 in the mixing vat 38 create polysaccharide networks that swell with the available water 20.

Once the plant powder 12 is mixed with water 20 and is given time to rehydrate, the brown rice flour 10 is added to the wet dough in the mixing vat 38. The albumin proteins 16 and the globulin proteins 18 in the brown rice flour 10 form hydrogen bonds with the polysaccharides 14 in the wet dough, therein creating the mucilage 22. The mucilage 22 binds the molecules of brown rice starch 24 together to create a final dough 30. The moisture content of the final dough 30 can be varied as needed to make the final dough 30 manageable for kneading, proofing, and baking. Within the final dough 30, the mucilage 22 binds the brown rice starch molecules 24 together and adds significant viscoelasticity to the final dough 30. This produces the final dough 30 with characteristics similar to whole wheat flour when used in baking recipes.

The slipper elm leaf 32 is made from leaves of the Ulmus rubra, or Slippery Elm tree. The tree genus Ulmus Rubra is a tree commonly found throughout eastern North America and east Asia. The leaves of the Ulmus Rubra tree are classified by the FDA as "generally recognized as safe" or GRAS. One mature Ulmus Rubra tree can hold about five-hundred pounds of leaves at any one time in a season. As such, if selectively pruned, a single Ulmus Rubra tree can produce from 500 to 1000 pounds of green leaves through a single season. Thus, large volumes of Ulmus Rubra tree leaves can be readily obtained at low costs.

The leaves of the Ulmus Rubra tree contain the needed polysaccharides 14 and long chain structural proteins that are sticky or slimy, therein providing the slippery elm tree with its common name. When mixed with brown rice flour 10, the polysaccharides 14 of the slippery elm leaves 36 bind the albumin proteins 16 and the globulin proteins 18 of the brown rice flour 10 in the manner previously described to create the mucilage 22. The mucilage 22 binds the starch molecules 24 of the brown rice flour 12 together.

The polysaccharides 14 needed to create the mucilage 22 are only present in the leaves of the Ulmus Rubra tree. Other parts of the Ulmus Rubra tree, such as the bark, roots or pulp, lack the needed polysaccharides and cannot be used.

The green leaves 32 of the Ulmus Rubra tree are harvested and washed in a wash plant 40. The clean leaves 32 are then either vacuum dried and/or freeze dried in a commercial dryer 42, such as a vacuum dehydrator or freeze dryer. This produces dehydrated leaves 44. The dehydrated leaves 44 are then ground in a mill 46 to produce leaf powder 50. The average particle size of the leaf powder 50 of between 10 um and 100 um is preferred so that the particle size is generally equivalent to that of the brown rice flour 10.

Okra powder 52 can be used in conjunction with, or in place of, the leaf powder 20 from the slippery elm. Okra 52 is the name given to the edible seed pod of the plant Abelmoschus esculentus. Okra 34 is high in vitamins A, C, K and B6. In addition, the okra 34 contains the polysaccharides 14 needed to bond to the albumin proteins 16 and globulin proteins 18 of the brown rice flour 12 to produce the mucilage 22.

The okra 34 is harvested, cleaned, and is then dried in a vacuum dehydrator or similar commercial dryer 54. This produces dried okra 56. The dried okra 56 is then ground into a powder in a mill 58. The okra powder 52 has an average particle size between 10 um and 100 um that is generally equivalent to that of the brown rice flour 10 and the leaf powder 20.

Chinese yam powder 60 can be used in conjunction with, or in place of, the leaf powder 20 from the slippery elm and the okra powder 52. Chinese yam is the common name given to the edible tubers of the plant Dioscorea polystachya 36. The Dioscorea polystachya 36 contains the polysaccharides 14 needed to bond to the albumin proteins 16 and globulin proteins 18 of the brown rice flour 10 to produce the mucilage 22.

The Dioscorea polystachya 36 is harvested, cleaned, and is then sliced and dried in a vacuum dehydrator or similar commercial dryer 62. This produces dried tuber 65. The dried tuber 65 is then ground into a powder 60 in a mill 66. The tuber powder 68 has an average particle size between 10 um and 100 um that is generally equivalent to that of the brown rice flour 10, leaf powder 50, and/or okra powder 52.

The slippery elm leaf powder 50, okra powder 52 and/or tuber powder 60 are all considered acceptable plant powders 12 due to the type and concentrations of polysaccharides 14 they contain. In the final dough 30, the composition of the solids is preferably between 90 percent and 99 percent brown rice flour (by weight) to 1.0 percent to 10 percent of one or more plant powders 12 (by weight). Water 20 is added in sufficient quantities to produce a kneadable dough.

The plant powder 12 added can be all leaf powder preferred embodiment at least two of the three plant powders 12 are used. If okra powder 52 and elm leaf powder 50 are used, the preferred ratio is at least four parts okra powder 52 to one part leaf powder 50. The same ratio is used if okra powder 52 and tuber powder 68 are used, wherein the preferred ration is at least four parts okra powder 62 to one part tuber powder 68. If all three plant powders 12 are used, at least four parts of okra powder 62 are used to 0.5 parts leaf powder 50 and 0.5 parts tuber powder. Finally, if only leaf powder 50 and tuber powder 68 are used, the powders are used in equal amounts.

In the mixing vat 38, the plant powder 12 is hydrated with water 20 to swell the chains of polysaccharides 14. After hydration, a pre-dough is present in the mixing vat 38. The brown rice flour 10 is added and thoroughly mixed with the pre-dough. This produces a homogenous gluten-free final dough 30 that has a light brown color similar to that of whole grain wheat flour dough. When used in a recipe viscoelasticity of the dough is enhanced by mucilage 22 that binds the starch molecules 24 together.

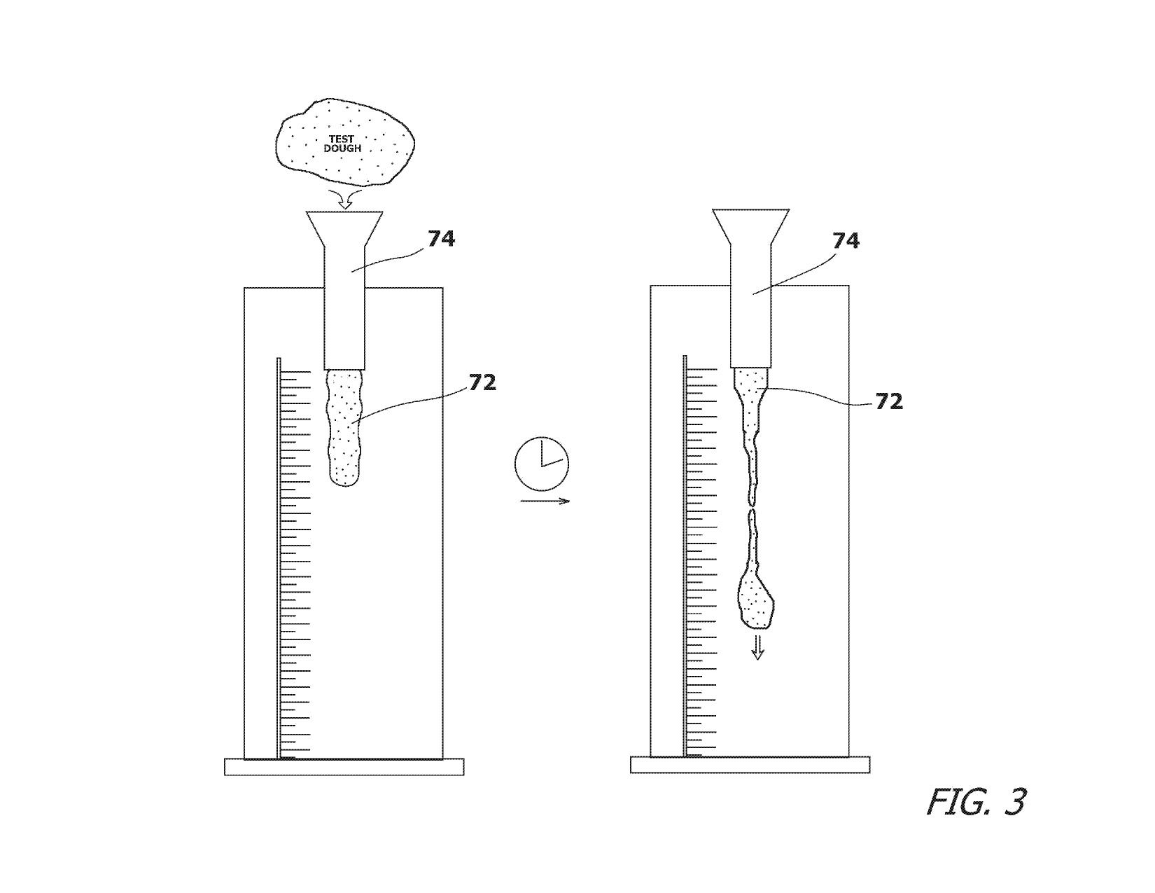

Formulations of the final dough 30 were tested in comparisons with two test controls. The first test control is a dough made from whole wheat flour and water. The whole wheat dough is 5%-7% water by weight. The second test control is a dough made purely from brown rice flour and water. The brown rice dough is 5%- 7% water by weight. The test performed is a viscoelasticity test. Referring to FIG. 3, it can be seen that a tube of test dough 72 is extruded from a tube 74 that is exactly one centimeter in diameter. Ten (10) centimeters of the test dough 72 is then extruded, wherein the extruded test dough 72 hangs freely from the tip of the extrusion tube 74. The test measures how far the test sample elongates over time under the force of gravity before the test sample fails. This test provides a direct indication of the viscoelasticity of the dough being tested. Dough with high viscoelasticity will deform significantly before breaking. Dough with low viscoelasticity will break more rapidly with less deformation. The goal is to produce a dough that has viscoelastic characteristics similar to that of the whole wheat control.

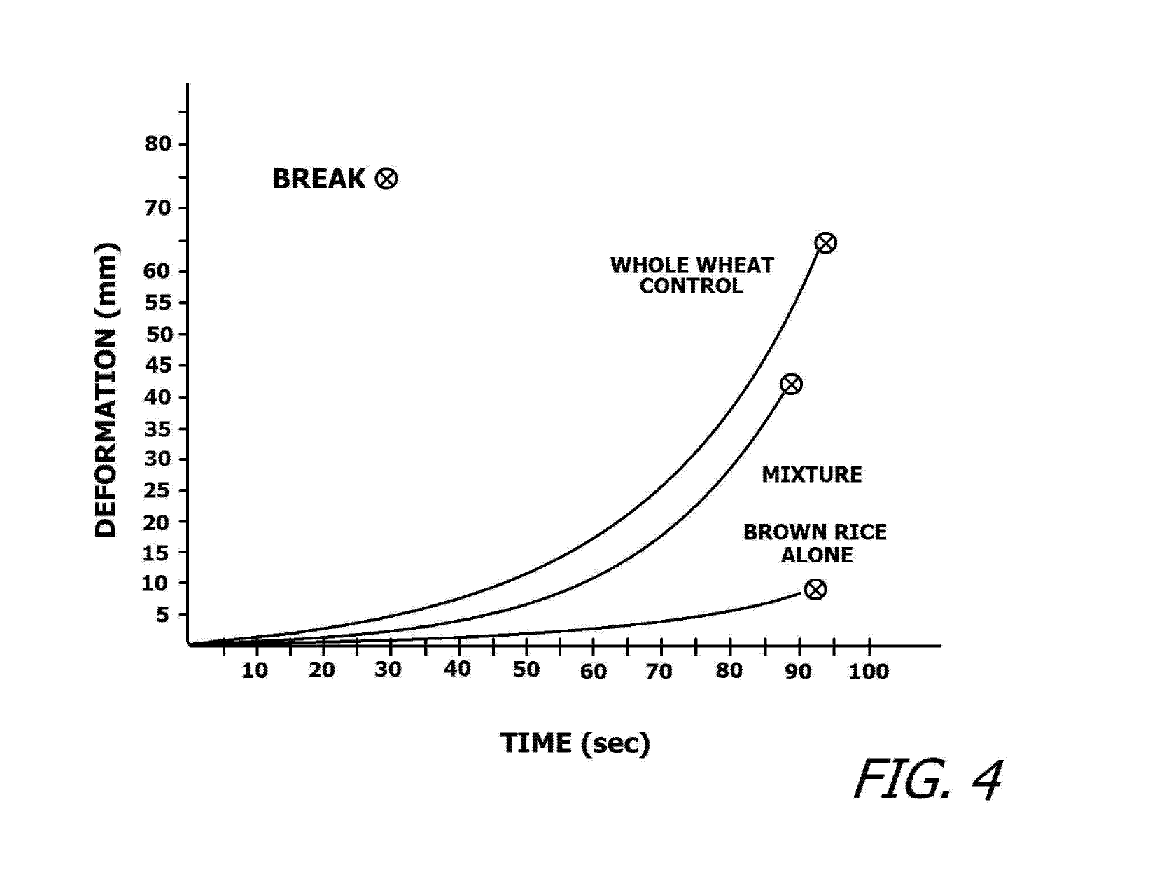

Referring to FIG. 4 the results of a first test set are presented. In the first test set, a gluten-free test dough is produced by mixing brown rice flour with both slippery elm leaf powder and okra powder in the percentages listed below.

### TEST COMPOSITION 1

Dry mix
Brown Rice flour - 90%
Slippery Elm Leaf powder- 5%
Okra powder- 5%
Plus, water -- 5%-7% by weight of dry mix.

As can be seen from the results of the test shown in FIG. 3, the addition of slippery elm leaf powder and okra powder to the brown rice improves the quality of the dough significantly. The viscoelastic characteristics of the dough are much closer to that of whole wheat flour. The viscoelastic characteristics of the test dough are further improved if the dough is leavened with yeast.

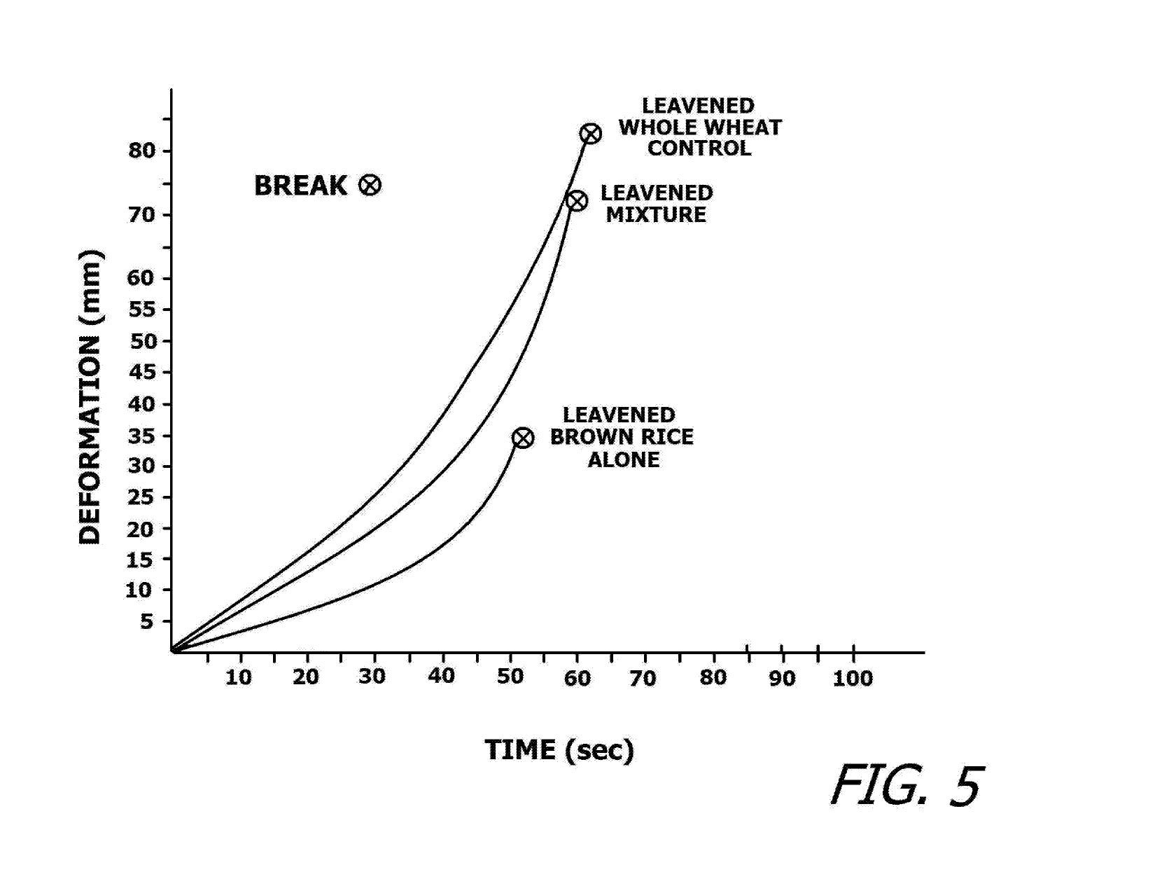

To leaven the dough being tested, the dough is mixed with activated yeast and is provided time to proof at room temperature for four hours. Referring to FIG. 5, it can be seen that when leavened with yeast, the viscoelasticity of the test dough is only a few percentages below the viscoelasticity of leavened wheat. Accordingly, in a recipe that calls for whole wheat flour, the composition of Test Composition 1 can be substituted with only a minor change to any dough being produced. The difference between the composition of Test Composition 1 and whole wheat flour would be unnoticeable to most all amateur bakers.

If mixed with yeast in a recipe, the gluten-free composition nurtures the growth of yeast in a manner similar to that of wheat flour. Furthermore, due to the elasticity of the dough, the dough can retain the carbon dioxide bubbles produced by the yeast in the same manner as wheat dough. This enables the dough to rise and expand in the same manner as wheat dough.

The composition in FIG. 3 and FIG. 4 uses both slippery elm leaf powder and okra powder in equal measures. This composition can be varied through a wide range of mixture ratios, provided the brown rice flour remains over 90% of the dry mix. Furthermore, high quality gluten-free flour can also be produced by using only slippery elm leaf powder or only okra powder.

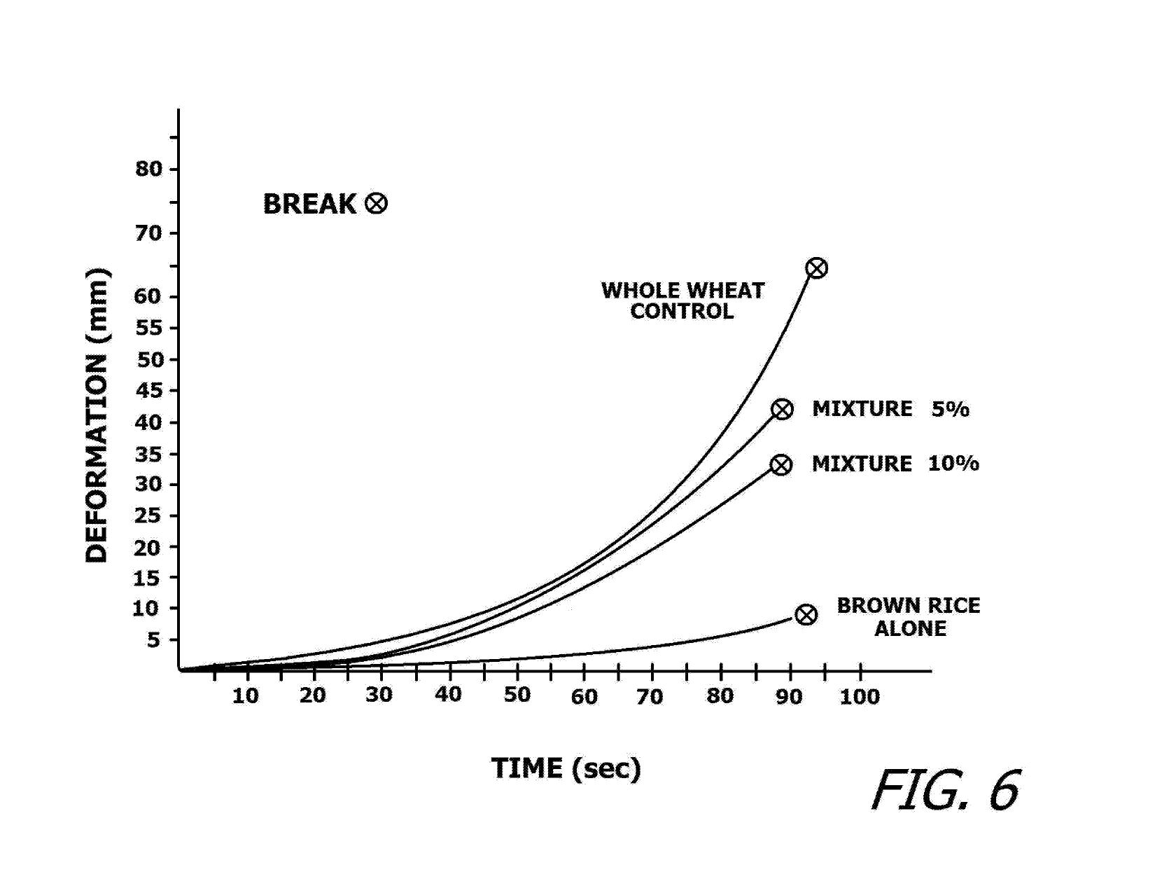

Referring to FIG. 6, the results of a third test set are presented. In the third test set, a gluten-free test dough is produced by mixing brown rice flour with only slippery elm leaf powder in the percentages listed below.

### TEST COMPOSITION 2

Dry mix
Brown Rice flour - 95% & 90%
Slippery Elm Leaf powder- 5% & 10%
Plus, water -- 5%-7% by weight of dry mix.

As can be seen from the results of the test shown in FIG. 6, the addition of slippery elm leaf powder to the brown rice powder improves the quality of the dough significantly. The viscoelastic characteristics of the dough are much closer to that of whole wheat flour. The viscoelastic characteristics of the test dough are further improved if the dough is leavened with yeast.

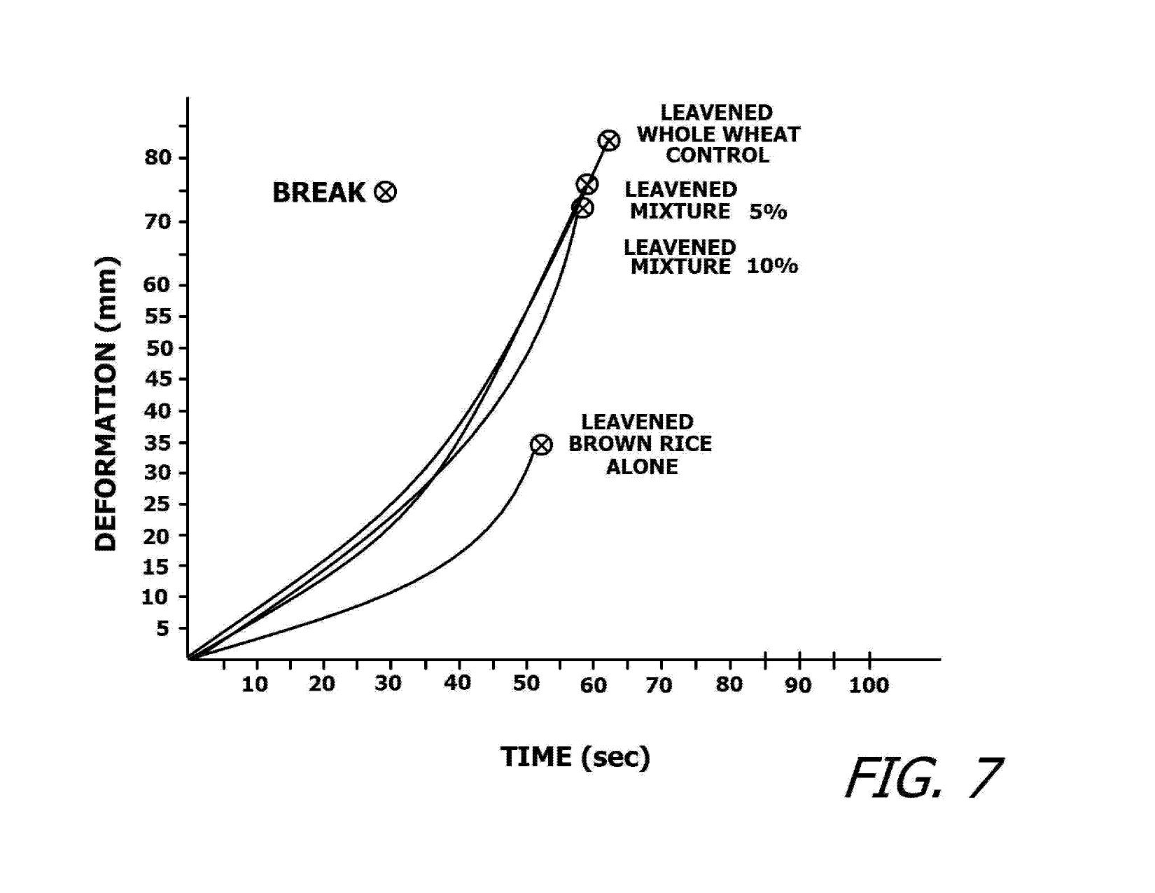

To leaven the dough being tested, the dough is mixed with activated yeast and is provided time to proof at room temperature for four hours. Referring to FIG. 7, it can be seen that when leavened with yeast, the viscoelasticity of the test dough only differs slightly from the viscoelasticity of leavened wheat. Accordingly, in a recipe that calls for whole wheat flour, the composition of Test Composition 2 can be substituted with no noticeable change to the dough being produced.

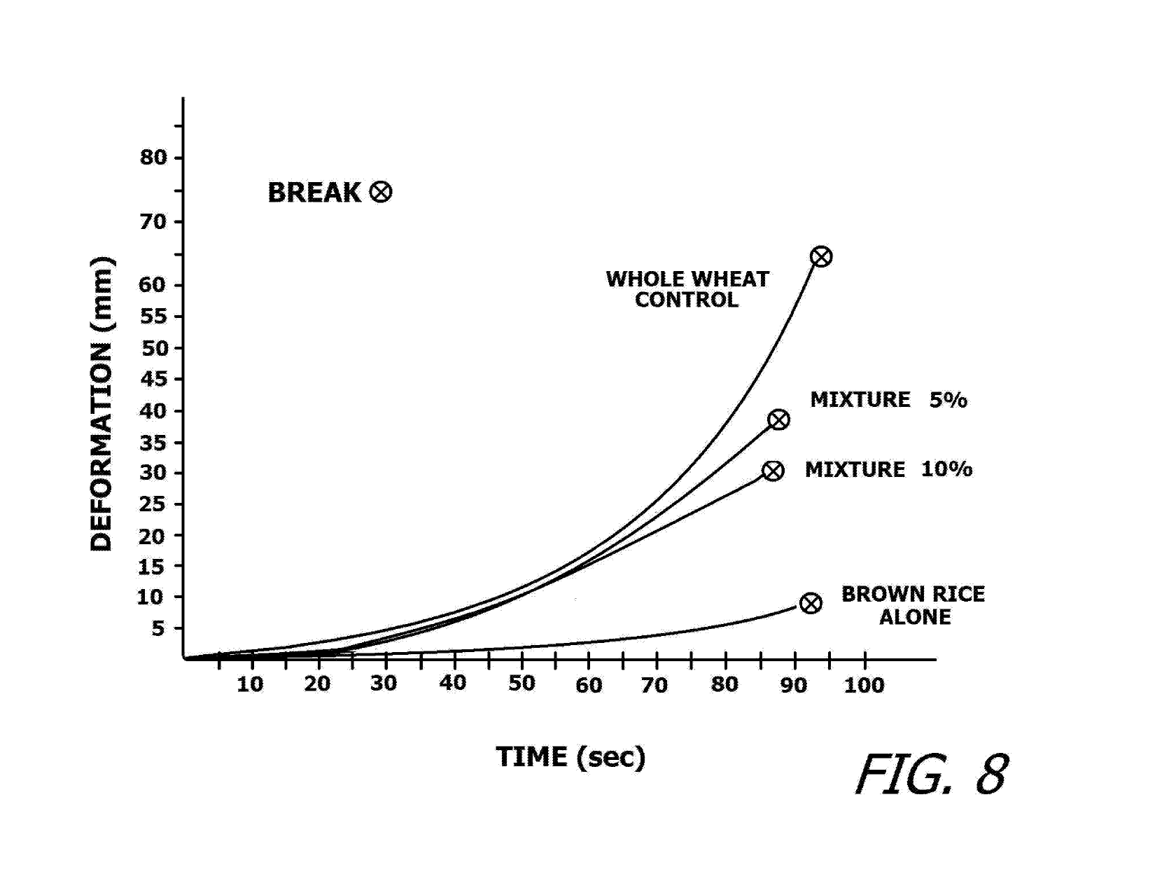

Referring to FIG. 8 the results of a fifth test set are presented. In the fifth test set, a gluten-free test dough is produced by mixing brown rice flour with only okra powder in the percentages listed below.

### TEST COMPOSITION 3

Dry mix
Brown Rice flour - 95% & 90%
Okra Powder - 5% & 10%
Plus, water -- 5%-7% by weight of dry mix.

As can be seen from the results of the test shown in FIG. 8, the addition of okra powder to the brown rice powder improves the quality of the dough significantly. The viscoelastic characteristics of the dough are much closer to that of whole wheat flour. The viscoelastic characteristics of the test dough are further improved if the dough is leavened with yeast. When leavened with yeast, the viscoelasticity of the test dough only differs slightly from the viscoelasticity of leavened wheat. Accordingly, in a recipe that calls for whole wheat flour, the composition of Test Composition 3 can be substituted with no noticeable change to the dough being produced.

In all of the test compositions, the result is a gluten-free composition that can be substituted for wheat flour in most any recipe that calls for wheat flour. The gluten-free composition produces a dough that has high elasticity and the ability to rise with yeast.

One of the strictest tests for gluten-free flour is its ability to produce pizza dough. Pizza dough is rolled thin and is cooked at high temperatures. Once cooked, it is expected that the cooked dough will maintain a good degree of elasticity and that the cooked dough will flex and fold without breaking. Prior art rice-based flours cannot be used to create a pizza dough that is not overly brittle. Using the present invention gluten-free composition, a dough can be created that can be used to make pizza dough, wherein the dough is stiff enough to support a slice of pizza yet is elastic enough to enable a slice of pizza to be folded without breaking.

It will be understood that the embodiments of the present invention that are illustrated and described are merely exemplary and that a person skilled in the art can make many variations to those embodiments. All such embodiments are intended to be included within the scope of the present invention as defined by the claims.

What is claimed is:

1. A method of producing a gluten-free dough for baking,
said method comprising:providing plant powder that contains polysaccharides, wherein said plant powder is derived from a group comprising slippery elm leaf, okra, and
dioscorea polystachya;mixing said plant powder with water to hydrate
said plant powder and create a pre-dough containing polysaccharide chains swollen with water;mixing brown rice flour into said pre-dough,
wherein said brown rice flour contains starch molecules, albumin protein, and globulin protein, and wherein said
polysaccharides chains bond to said albumin protein and said globulin protein with hydrogen bonds creating a mucilage;wherein said mucilage binds said starch molecules creating a viscoelastic dough.

2. The method according to claim 1, wherein said brown rice flour is at least 90% by weight as compared to said plant powder.

3. The method according to claim 2, further including mixing said pre-dough for at least five minutes prior to adding said brown rice flour.

4. The method according to claim 1, wherein said brown rice flour and said plant powder have particle sizes between 10 um and 100 um.

5. The method according to claim 1, wherein said plant
powder contains okra powder and slippery elm leaf powder.

6. The method according to claim 5, wherein said okra powder is present in at least a 4:1 ratio in comparison
to said slippery elm leaf powder.

7. The method according to claim 1, wherein said plant powder contains okra powder and dioscorea polystachya powder.

8. The method according to claim 7, wherein said okra powder is present in at least a 4:1 ratio in comparison to said dioscorea polystachya powder.

9. The method according to claim 1, wherein said plant powder contains slippery elm leaf powder and dioscorea polystachya powder.

10. The method according to claim 9, wherein said slippery elm leaf powder and dioscorea polystachya powder are present in equal weights.

11. A method of producing a gluten-free dough for
baking, said method comprising:providing plant powder that contains polysaccharides, wherein said plant powder is derived from a group comprising slippery elm leaf, okra, and
dioscorea polystachya;mixing said plant powder with water to hydrate said plant powder and swell said polysaccharides.mixing in brown rice flour that contains starch molecules, albumin protein, and globulin protein, wherein said polysaccharides bond to said albumin
protein, and said globulin protein with hydrogen bonds creating a mucilage and wherein said mucilage binds said starch molecules creating a viscoelastic dough.

12. The method according to claim 11, wherein said brown rice flour is at least 90% by weight as compared to said plant powder.

13. The method according to claim 11, further including mixing said plant flour with water to create a pre-dough prior to adding said brown rice flour.

14. The method according to claim 11, wherein said brown
rice flour and said plant powder both have particle sizes between 10 um and 100 um.
